(19) United States
(12) Patent Application Publication
(10) Pub. No.: US 2003/0210154 A1
(43) Pub. Date: Nov. 13, 2003

(54) Process for the control of industrial or construction machinery

(76) Inventors: Wolfgang Bredow, Niefern-Oschelbronn (DE); Thomas Burchard, Pforzheim (DE); Thomas Haug, Olbronn (DE)

Correspondence Address: CANTOR COLBURN, LLP, 55 GRIFFIN ROAD SOUTH, BLOOMFIELD, CT, 06002

(21) Appl. No.: 10/379,954

(22) Filed: Mar. 5, 2003

(30) Foreign Application Priority Data
Mar. 6, 2002 (DE) 102 09 965.0

(51) Int. Cl. H04Q 1/00

(52) U.S. Cl. 340/825.25; 340/310.01

(57) ABSTRACT

A process for the control of a plurality of industrial, construction or mobile hydraulic machines, such as cranes, travelers and similar machines, by means of n remote control units (S1 . . . Sn), allocates the remote control units to k concentrators (K1 . . . Kk), whereby the number (k) of concentrators is smaller than the number (n) of remote control units. Preferably, only a single concentrator (K) is provided. The concentrator (K) provides the signals from the remote control units with a suitable address and transmits them via a common data network, such as the power grid (AC), to which the concentrator (K) and control devices (ST1 . . . STm) for the m power units of the industrial machines to be controlled are connected in such a way that a signal is recognized by its address and converted into the control signal for activation of the respective power unit.

### TECHNICAL BACKGROUND

The invention concerns a process for the control of a plurality of industrial or construction machines which are connected to the same electrical power grid, or mobile hydraulic machines such as cranes, travelers and similar machines, by radio remote control, according to the preamble of Patent claim 1.

The remote control of a plurality of industrial or construction machines, such as cranes, travelers or similar machines, which are located, for example, on construction sites or in workshops for the assembly of industrial goods—i.e. setting the type, duration and direction of the determining courses of movement in respect of each machine, through the selection of a suitable motor—is, basically speaking, known from prior art. To this end, for each radio receiver, which is allocated to the power unit of an industrial or construction machine that is to be controlled, a corresponding transmitter is provided, by means of which the industrial machine concerned may be operated. In this process, care must be taken to ensure that the control channels, which are used for transmission of the control commands, differ from each other according to at least one criterion which can be distinguished by the receivers concerned—for example, radio frequency. This solution assumes that a separate radio receiver will be used for each power unit to be controlled, thus rendering the solution expensive.

### STATE OF THE ART

For domestic use, the connection of a plurality of users to a data line and the subsequent activation by means of a control unit connected likewise to the data line—for example, in order to turn on a television set—is known from prior art (DE 197 45 210 A1).

Again for domestic use, the control of electrical household products—such as lighting installations or electronic entertainment devices—through the use of a common hand-held device with a remote control connection, which controls a common receiver, is also known from prior art (DE 28 00 472 C2). Said common receiver transmits the received remote control signal, by means of the domestic mains supply, to units allocated to the respective appliances, which generate, on the basis of the transmitted signal, the requisite switching information for the device—for example, the television set—and perform the switching function. The use of the AC power grid serving the household for the transmission of signals is also known in connection with other applications, such as for monitoring purposes (“electronic babysitter”) or as a carrier for data information (“Internet e socket”).

### REPRESENTATION OF THE INVENTION

The objective of the invention is to significantly simplify the control functions for construction and industrial equipment located other than within small buildings, which are remotely controlled by several operators with remote control transmitters.

This objective is solved according to the invention as described in the characterizing clause of Patent claim 1.

The basic concept of the invention consists of bundling the data communication—which, to date, was transmitted directly from the individual remote-controlled transmitters to the individual receivers for the respective power units of the industrial and construction machines—in a small number of devices, preferably only a single device, which is referred to hereinafter as the “concentrator”, which exercises the function formerly performed by the plurality of receivers, and which transfers the information received by each one of the remote control transmitters by way of an appropriate communications network (data bus). The respective power unit to be controlled on each of the industrial machines will then no longer require its own remote control receiver, but rather, in the simplest case, only a less technically demanding control device with a decoder, which filters “its” control signal out of the data bus and obtains a control signal for the control of the respective motor of the power unit.

Accordingly, the common concentrator as described above serves as a switching exchange between a certain number of remote-controlled transmitters, on one hand, and, on the other, a number of decoders in the control devices of the power units of the industrial machines.

The savings, which are accomplished through the omission of individual radio receivers, may be increased in applications involving great distances through the use of the existing electrical power grid, in a manner involving minimization of the required cable lengths.

A further advantage of the approach adopted by the invention lies in the fact that the control devices allocated to the power units may also, as necessary, be simply equipped or provided with an encoding function, by means of which the control units of various industrial machines may similarly communicate with each other by means of the communications network. This opens up an especially broad range of possibilities in cases which require the coordination of two or more power units in order to achieve a common outcome—for example, the transport of a prefabricated concrete part by means of two travelers running parallel to each other, which can coordinate their course with each other in a simple manner by means of sensors over the communications network, thus guaranteeing an extremely precise transport of the prefabricated concrete part.

Another range of applications for this “internal communication” involves the coordination of the course of travel of power units, such as crane arms or pivot arms, with overlapping work areas. By transmitting their respective positions and performing adjustments in relation to each other, they can ensure, for example, that one crane arm will only enter an overlapping work area of this type if the crane arm of another crane, which is working parallel to it, is not present in that work area. Such a possibility serves to increase the operational safety of the entire installation.

The type of data transmission and/or communication via the data bus may be implemented by means of various ways, they known from prior art (for example, over the AC power line of the electrical power grid). In this connection, it is advantageous for the communication system running from the common concentrator to the control devices and the internal communication system between the various control devices to be coordinated with each other and optimized relative to each other.

### BRIEF DESCRIPTION OF THE DRAWINGS

A preferred embodiment of the solution according to the invention is explained in greater detail below, by means of drawings, which show:

FIG. 1: a block diagram of an arrangement for implementation of the procedure according to the invention, and

FIG. 2: the arrangement of the components in an environment, which includes industrial machines.

### DESCRIPTION OF THE EMBODIMENT

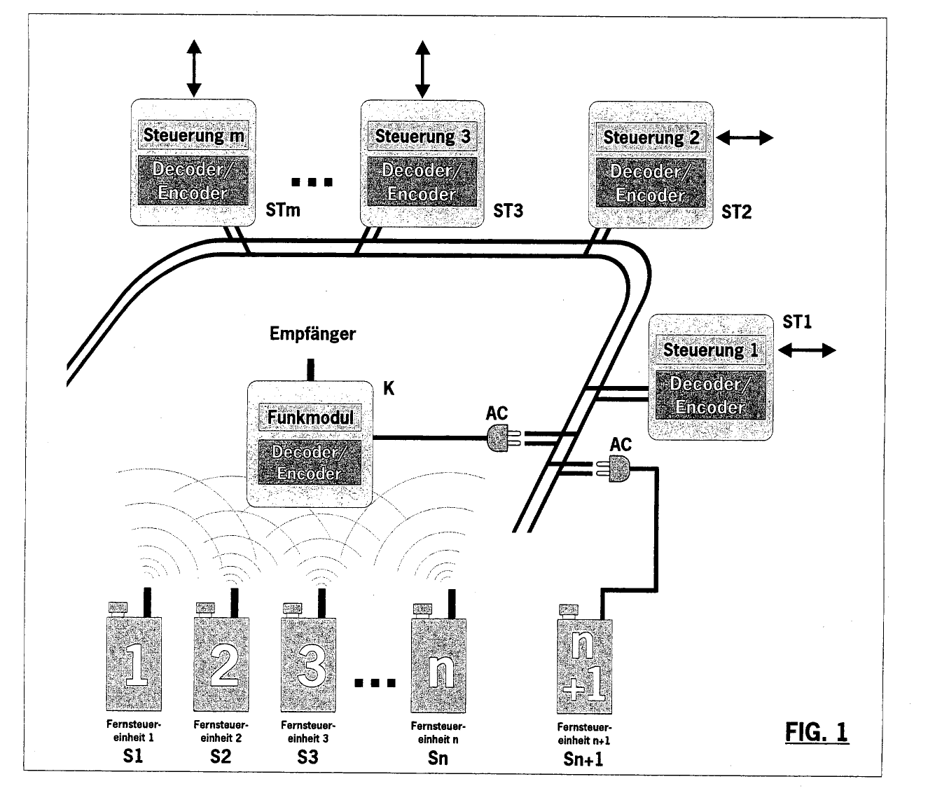

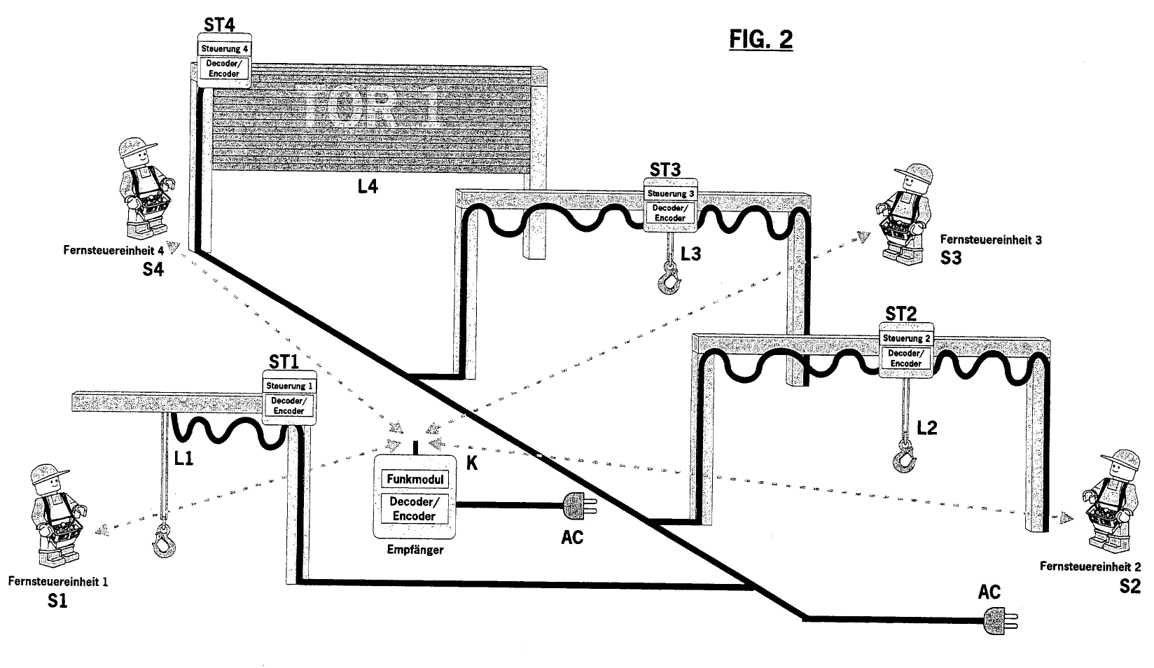

FIG. 1 shows n remote control units S1 . . . Sn, whose signals are decoded by a concentrator K, thus especially acquiring the information which indicates which of the control devices ST1 . . . STm of the m power units to be controlled within the entire installation is intended to receive the information concerned.

The concentrator K, in its capacity as a switching exchange, includes both facilities for reception and decoding of the signals of the remote control units S1 . . . Sn and facilities for the encoding of these signals and transmission to a data network (data bus).

If bidirectional communication between the remote control units S1 . . . Sn and the concentrator K is desired (feedback channel), the transmission facilities required for this purpose must also be included within the concentrator K, and reception facilities must also be present within the remote control units S1 . . . Sn.

The n remote control units S1 . . . Sn operate on n differentiable transmission channels, whereby the differentiation can be defined and decoded by the concentrator in a manner known from prior art—for example, by means of different frequencies, or by means of different pause lengths between transmitted data packets.

The concentrator K is connected to a data network—in the embodiment represented here to the AC power grid (for example, 380 VAC), as are the in control devices ST1 . . . STm, each of which is located in the immediate vicinity of a power unit that is to be controlled (for example, a motor M) of the industrial or construction machine, or of a mobile hydraulic machine. Each of the control devices ST1 . . . STm has a decoder, which is coordinated with the encoder contained within the concentrator K in such a way that an item of information which is encoded by the concentrator K and intended for the control device STm of a certain power unit (motor M) will be decoded by that control device and can be converted into a control signal suitable for controlling the power unit m.

According to a preferred embodiment, each of the m control devices ST1 . . . STm is also equipped with an encoder, whose function basically corresponds to the function of the encoder in the concentrator K, thereby making it also possible to exchange information between the control devices themselves, as explained above.

As an advantageous complement to the system, it is possible to integrate a control unit Sn+1, which does not create the connection to the AC power grid by means of a radio connection, but rather is directly connected thereto. In such a case, it must also be ensured that this control unit Sn+1 is also equipped with a suitable encoding facility.

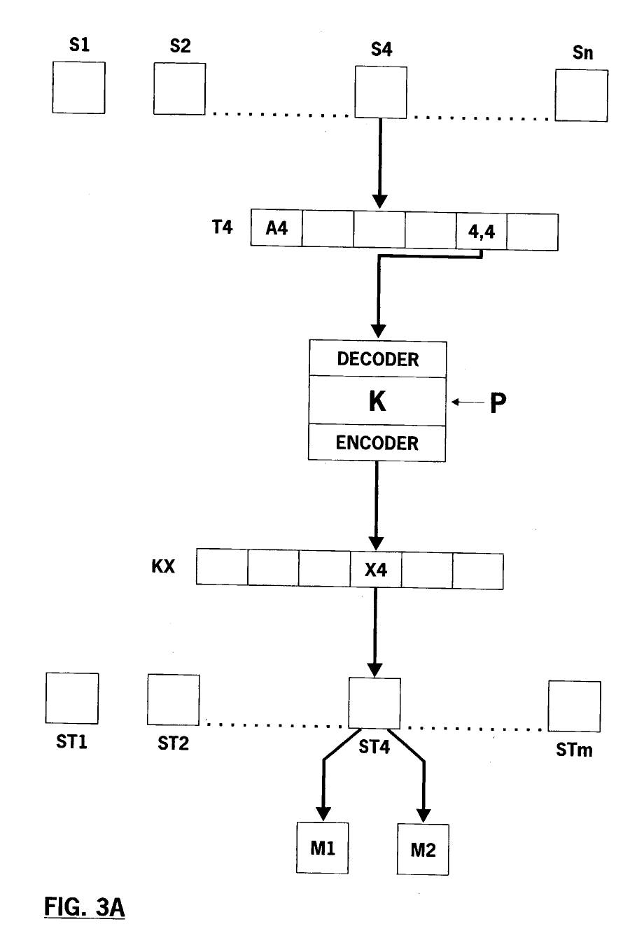

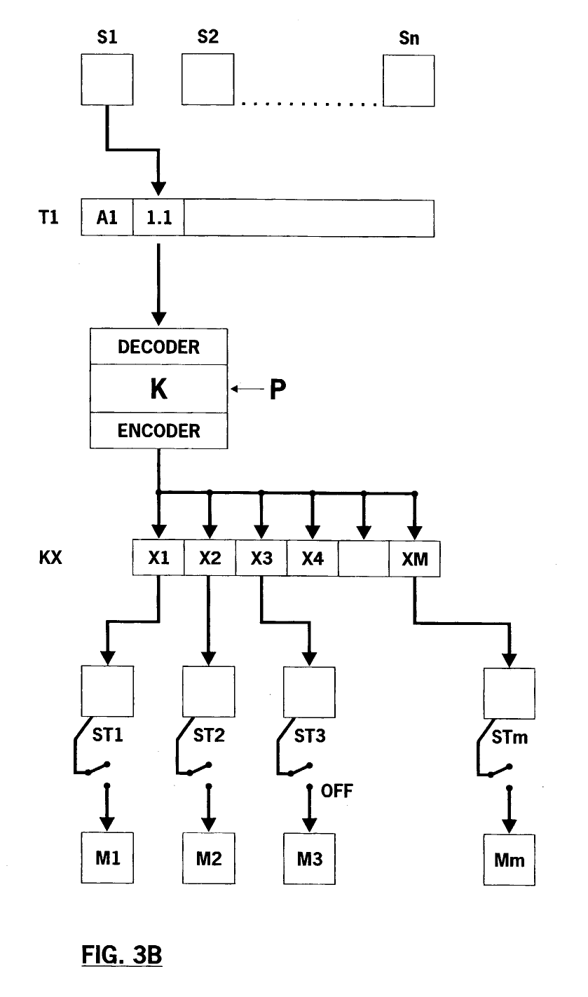

FIG. 2 shows a concrete example of application of the process according to the invention, with industrial machines located in a precise spatial arrangement relative to each other, within a working area—specifically, three travelers L1, L2 and L3 and a roller shutter R—in a production or assembly hall. These four machines are controlled by four remote control units S1 . . . S4 by means of the concentrator K and the AC power grid. In such a case, any desired arrangement of remote control units S1 . . . Sn and power units to be controlled may be used.

Communication in this system, by means of a power line of the AC power grid, which functions as a data bus, is according to basic principles (a “telegram” with an address section and information section) which are known from prior art, and may be explained in greater detail, by way of example, by means of two diagrams:

FIG. 3A shows the information transfer, where the remote control unit S4, by means of the control device ST4, is intended to activate, for example, motor M1 of a crane lifting hoist on a crane. The information of the remote control unit S4 occupies the fourth location 4.4 in a data packet referred to below as “Telegram T4”. In the concentrator, the address A4 of the remote control unit S4 is identified and, if necessary, checked to ensure whether the remote control unit S4 is authorized to control the control device ST4—i.e. whether the address of the control device involved has been allocated to the remote control unit. The information to be transmitted is then converted by the concentrator, by means of memorized allocation functions (which are defined and can be modified by means of a programming input P), into a telegram KX at a location X4 which is allocated to the control device ST4, and transmitted via the data network. The decoder of the control device ST4 recognizes the information and uses it to generate a control signal for the motor M1.

FIG. 3B shows the information transfer, where the remote control unit S1 is intended to transmit an emergency “OFF” signal for all power units m of the entire installation (such as the machines in a production hall). In a telegram T1, this information occupies the first location 1.n. The concentrator, in its memory, holds an “emergency OFF allocation”, according to which it converts an information item contained in the first section of a data telegram, in Telegram KX, into an emergency OFF information item on all channels X1 . . . XM, i.e. for all of the control devices ST1 . . . STm. This information is recognized by all of the control devices and converted, in such a way as to cause all of the power units M1 . . . Mm to switch off—as shown symbolically by the open switch in the drawing.

1. Process for the remote control of a plurality of industrial or construction machines, such as cranes, travelers and similar machines, whereby a control channel is assigned to each industrial machine to be controlled, such that the signal of said control channel is converted into a control signal for the activation of one of the m power units of the m industrial machines,
wherein n remote control units (S1 . . . Sn) are allocated to k concentrators (K1 . . . Kk), whereby the number (k) of concentrators is smaller than the number (n) of remote control units, and wherein the concentrators provide the signals from the control channels with an address and make them available by means of a common data network, to which the concentrators (K1 . . . Kk) and the control devices (ST1 . . . STm) for the m power units of the industrial machines to be controlled are connected, in such a way that a signal is recognized by its address and converted into the control signal for activation of the respective power unit.

2. Process according to claim 1, wherein a common concentrator (K) is provided (k=1).

3. Process according to claim 1, wherein control information is similarly exchanged, by way of the common data network, between the control devices (ST1 . . . STm) of a plurality of industrial machines, whereby the type of addressing used by the concentrator (K) is applied.

4. Process according to claims 1 to 3, wherein a transmitter datum is added to the control information items for identification of the concentrator (K) and the control devices (ST1 . . . STm).

5. Process according to claim 1, wherein the address of one control device (ST1 . . . STm) is conveyed by the concentrator (K) to only one of the remote control units (S1 . . . Sn).

6. Process according to claim 1, wherein the remote control units (S1 . . . Sn) operate on a fixed frequency of the concentrator (K), and wherein a different pause length between the data telegrams sent from it to the concentrator is allocated to each control channel.

7. Process according to claim 1, wherein different frequencies are allocated to the control channels of the remote control units (S1 . . . Sn), and said frequencies are cyclically queried by the concentrator (K).

8. Process according to claim 1, wherein the address of one control device (ST1 . . . STm) is conveyed by the concentrator to a plurality of remote control transmitters (S1 . . . Sn).

9. Process according to claim 1, wherein the address of one remote control unit (S1 . . . Sn) and parts of the information sent by it within the telegram are conveyed to various control devices (ST1 . . . STm).

10. Process according to claim 1, wherein the data network is the power grid (AC).

11. Process according to claim 10, wherein the communication of the decoder/encoder of the concentrator (K) and the control devices (ST1 . . . STm) is transmitted by means of a standard protocol (such as CAN-Bus).

12. Process according to claim 1, wherein the data network is a DC power grid.

13. Process according to claim 1, wherein the communication between the remote control units (S1 . . . Sn) and the concentrator (K) is bidirectional.
